(19) United States
(12) Patent Application Publication
(10) Pub. No.: US 2015/0019378 A1
(43) Pub. Date: Jan. 15, 2015

(54) Data Processing Tool to Facilitate Secure and Confidential Interaction Among Buyers, Sellers and Real Estate Agents With Anti-Spoofing Mechanism

(71) Applicant: Brent Hickey, Chandler, AZ (US)

(72) Inventor: Brent Hickey, Chandler, AZ (US)

(21) Appl. No.: 14/499,848

(22) Filed: Sep. 29, 2014

Related U.S. Application Data
(60) Provisional application No. 60/866,401, filed on Nov. 17, 2006.

(51) Int. Cl. G06Q 30/06; G06Q 50/16

(52) U.S. Cl. CPC G06Q 30/0613; G06Q 50/16
USPC 705/26.41

(57) ABSTRACT

The network-based data processing tool facilitates selection and engagement of a real estate broker and providers of ancillary services in a confidential and secure manner. The tool includes a database that automatically stores historical commission bid data and uses that bid data to assist a user in selecting and engaging a real estate agent. To maintain confidentiality agents are only provided with knowledge of potential Buyer and Seller interest if those parties have actively requested bids from those agents. In addition, actual bid amounts are not visible to other agents. The Tool includes an anti-spoofing feature that detects if when an agent attempts to masquerade as a buyer or seller to use the tool to investigate what fees other agents are bidding.

### CROSS-REFERENCE TO RELATED APPLICATIONS

This application claims the benefit of U.S. Provisional Application No. 61/886,401, filed on Oct. 3, 2013. The entire disclosure of the above application is incorporated herein by reference.

### FIELD OF THE DISCLOSURE

The present disclosure relates generally to electronic data processing tools to facilitate selection and engagement of a real estate broker and providers of ancillary services in a confidential and secure manner. More particularly the disclosure relates to a tool that facilitates communication between buyers, sellers and agents in a confidential and secure manner over the Internet.

### BACKGROUND

This section provides background information related to the present disclosure which is not necessarily prior art.

Currently buyers and sellers of real property (real estate) retain the services of a real estate agent, broker or realtor, who represents the buyer or the seller in negotiating for the purchase or sale of real estate and in handling or assisting in many of the routine steps taken attendant to such purchase or sale. For example, the buyer's agent typically assists his or her client in finding a suitable piece of real property, guiding the client through an on-site viewing of the property, making recommendations as to the value of that property, assisting the buyer in making purchase offers and in considering seller's counter offers, and finally in assisting the buyer in executing the legal forms necessary to consummate the purchase. In addition to these typical steps, the buyer's agent will sometimes also advise the buyer in obtaining pre-approved mortgage financing, and in obtaining title searches, property inspections and other ancillary services from third party banks, title search companies and property inspection companies.

The seller's agent will typically perform similar duties on behalf of the seller, including, assisting the seller in listing his or her property with various real estate listing services (e.g., MLS), making recommendations as to the value of the property, meeting with potential buyers to view the property, receiving purchase offers, assisting the seller in evaluating purchase offers and in making counter offers, and in assisting the seller in executing the legal forms necessary to consummate the sale. In addition to these typical steps, the seller's agent will sometimes also advise the seller in obtaining property inspections, obtaining pre-sale property repair services, and the like.

In conventional practice, real estate brokers typically charge a fixed percentage of the selling price of the property (e.g., 6%) in payment for the provided services. By widespread practice this fee or commission is non-negotiable.

While a particular buyer or seller is always free to ask an agent to accept a reduced fee or commission, the agent has little motivation to agree to reduce the fee, as the agent knows that all of the agent's competitors are charging the same fee. Of course a particular buyer or seller could walk from office to office, asking each agent in turn if he or she will accept a lower fee. The answer will be the same: “no.”

The disclosed electronic data processing system seeks to change all of this. However, in doing so it must solve the heretofore insurmountable problem of how to empower the buyer or seller to effectively negotiate for a reduced fee, without encountering the stonewall reality that all agents charge the same rate—and that all agents know this and have absolutely no motivation to deviate from the lucrative status quo.

### SUMMARY

This section provides a general summary of the disclosure, and is not a comprehensive disclosure of its full scope or all of its features.

The disclosed data processing apparatus provides a tool that can be employed by a real estate buyer or seller, to first identify a pool of real estate agent candidates with whom the buyer or seller finds trustworthy and to then submit a request for bids from that pool of agents, in a confidential and secure manner, that substantially inhibits each agent from colluding to charge a standard 6% fee, and that substantially inhibits agents from “gaming the system” by spoofing their identity (acting as a potential buyer or seller) to learn what competitors are charging.

The apparatus, a data processing tool, automatically stores historical commission bid data and uses that bid data to assist a user in selecting and engaging a real estate agent. In the description that follows, it will be understood that references to use of a computer are intended to include not only computers deployed at a fixed location but also computers that are mobile devices.

More specifically, the data processing tool includes a computer-readable memory device having first memory locations allocated by the computer to store historical commission records comprising an agent identifier and an associated value indicative of a commission for representation in connection with a transaction. The computer-readable memory device has second memory locations allocated to store agent qualification records comprising an agent identifier and at least one associated datum indicative of an agent qualification.

The computer is programmed to access the first and second memory locations and to perform a query that retrieves agent identifiers that associate with at least one of a user specified value indicative of a commission and a user specified datum indicative of an agent qualification.

The computer is further programmed to store in a third memory location of said computer-readable memory device the agent identifiers retrieved from said query and to generate a first report to the user that supplies at least the agent identifier for all agents who meet at least one of the commission and agent qualification corresponding to the user specification.

The computer is further programmed to post a request for commission bid on behalf of the user to each agent corresponding to the retrieved agent identifiers. The computer is further programmed to receive and store in a forth memory location of said computer-readable memory device a commission bid reply from at least one agent having received the posted request for commission bid.

The computer is further programmed to generate a second report to the user that supplies at least the agent identifier and associated commission bid reply for all responding agents having replied to the posted request for commission bid. The computer is further programmed to store in said historical commission records the agent identifier of one of the responding agents together with the associated commission bid reply based upon selection of the one responding agent by the user.

According to a further aspect, the computer is programmed to include an anti-spoofing mechanism to inhibit a user registered as an agent from masquerading as a buyer or seller comprising a data store of IP addresses compiled by the computer based on previous user registrations and comprising executable computer program code that causes the computer to perform an automatic comparison of the IP address of the user against the data store of IP addresses.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a system block diagram of an internet-based embodiment of the electronic data processing tool;

FIG. 2 is a process flow diagram depicting one aspect of the electronic data processing tool;

FIGS. 3a and 3b are database schema diagrams used in implementing the backend database of the electronic data processing tool;

FIGS. 4-14 are flowchart diagrams depicting how a processor of the Tool is programmed to implement an embodiment of the middleware;

FIG. 15 is a flowchart diagram depicting how a processor of the Tool is programmed to implement the anti-spoofing check and usage blocking;

FIG. 16 is a diagrammatic web page screen illustrating an exemplary Seller signup entry form;

FIG. 17 is a diagrammatic web page illustrating an exemplary Agent search form;

FIG. 18 is a diagrammatic web page illustrating an exemplary Agent bid request form with POST IT button to initiate the automated bid request process;

FIG. 19 is a diagrammatic web page illustrating an exemplary Agent bid entry and management form.

Corresponding reference numerals indicate corresponding parts throughout the several views of the drawings.

### DESCRIPTION OF PREFERRED EMBODIMENTS

Example embodiments will now be described more fully with reference to the accompanying drawings. Before presenting a detailed explanation of the data processing tool, however, a brief overview of the functionality provided by the tool will first be given.

### Location, Location, Location

Real estate is fundamentally different from personal property in that each parcel of real estate is unique, simply because it occupies a unique geographic position on planet Earth. Two houses can sit side-by-side in the same neighborhood, yet one house has a panoramic view of the distant mountains while the other has a view of the backside of a neighboring house. Which one is more valuable? For most buyers it is the house with the view.

When shopping for real estate, buyers may have some ideas about what they are looking for—ranging from general notions to very specific requirements. Yet buyers in general may be unfamiliar with a particular neighborhood. They may not know what homes are offered for sale; they may not know what the various unique locations within the neighborhood may have to offer. Conversely, sellers know what their property has to offer, but they often have difficulty assessing what the current market is willing to pay. Sellers have difficulty truly appreciating the value of their neighborhood in general and more particularly of their unique location.

Thus buyers and sellers have traditionally relied upon the services of real estate agents, who take the time to learn the neighborhood and to discover the unique aspects about each unique location. Thus real estate agents serve an important role in putting together the right buyer with the right seller.

Traditionally the fees charged by real estate agents have been fixed, on a market-by-market basis. In many residential markets throughout the United States, the traditional real estate fee or commission is 6% of the selling price of the property. That fee may be different in commercial markets or in large metropolitan areas; but typically some non-negotiated fixed fee will be charged, even if it is not 6%.

Technically speaking, the traditional fixed fee is not cast in stone; yet practically speaking, buyers and sellers have no real opportunity to negotiate the commission fee. A major reason for this is that buyers and sellers have no practical opportunity to play one agent against another to secure a lower rate. Agents must be interviewed office-by-office, one-at-a-time. There is no “job fair” or “silent auction” where agents all gather in a room and bid on the rate they are willing to charge a particular buyer or seller. Moreover, agents have no motivation to change the status quo.

The disclosed data processing tool is designed to break the status quo, by giving buyers and sellers a tool by which they can interview a pool of agents en masse and request agents of their choosing to submit bids in a private and secure manner. The tool is designed to keep the identity of the buyer and seller confidential from agents who have or have not been invited to bid. Thus buyers and sellers do not have their personal information about their buying and selling desires spread across the internet. In addition the tool is designed to prevent agents from spoofing the system, by acting as a buyer or seller, in order to learn what competitors are bidding. The preferred embodiment of the data processing tool is implemented by a computer or system of computers that are connected to the internet to allow buyers, sellers and agents to interact with the tool using web browser technology.

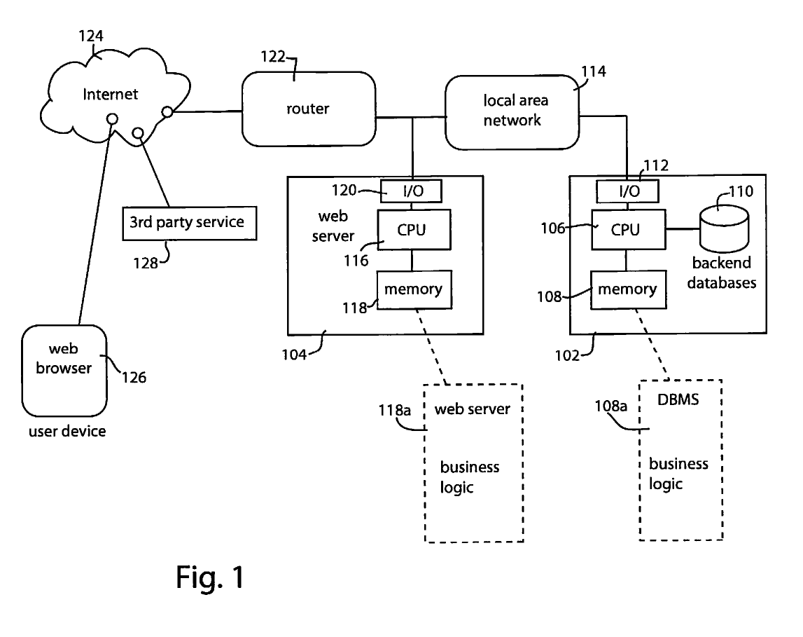

FIG. 1 illustrates an exemplary computer hardware implementation of the data processing tool. In the illustrated embodiment two computers have been illustrated: the backend database computer 102 and the web server computer 104. If desired, the functions of these respective computers can be consolidated into a single computer. Alternatively, more than two computers can be used, for example, to place the web server, middleware, and database management functions on separate computers. Thus it will be appreciated that FIG. 1 is intended as one example; other embodiments are also possible.

The backend database computer 102 has a processor or CPU 106 with attached memory 108, a storage system 110 and a suitable input/output (I/O) port 112 by which the computer 102 is connected to a network, such as local area network 114.

As diagrammatically illustrated at 108a, the computer memory stores executable code to implement a database management system (DBMS) and also, if desired, the business logic to implement the functions described above. Although there are many choices, a suitable database management system may be implemented using commercially available products such as Oracle, MYSQL, Microsoft SQL Server and the like. The business logic may be implemented in a variety of different compiled or interpreted programming languages, such as C++, C#, PHP, Python, Ruby or the like.

The web server computer 104 similarly has a CPU 116, memory 118 and a suitable input/output (I/O) port 120. The web server computer is coupled to local area network 114 to allow data communication with the backend database computer. The web server computer is also coupled through a suitable router 122 to the Internet 124. The web server is configured and programmed to define a web site accessible via the Internet, whereby users may interact with the tool using a suitable web browser, such as at 126. The web server is also configured with the capability to pass the URL of various third party service sites 128 to users when certain features are requested, such as home inspection, pest inspection and the like. This programming is stored in the memory 118 of the computer, which has been diagrammatically illustrated at 118a to include suitable web server software and business logic software. For example, the web server may be implemented using commercially available Apache web server or Microsoft IIS software. As discussed above the business logic may be implemented in a variety of different compiled or interpreted programming languages, such as C++, C#, PHP, Python, Ruby or the like. Generally it is a matter of design choice as to whether to place the business logic on the web server computer or on the backend database computer. Interface-related business logic may be conveniently located on the web server, for example; while data manipulation-related business logic may be conveniently located on the backend database server.

The web server computer and backend database computer cooperatively interact to generate the functionality and user experience illustrated and described herein. The web server receives interactive commands and data from the user, via the user's browser. The web server then issues queries to the backend database, to retrieve information to be presented to the user; or to store information in the database that has been provided by the user.

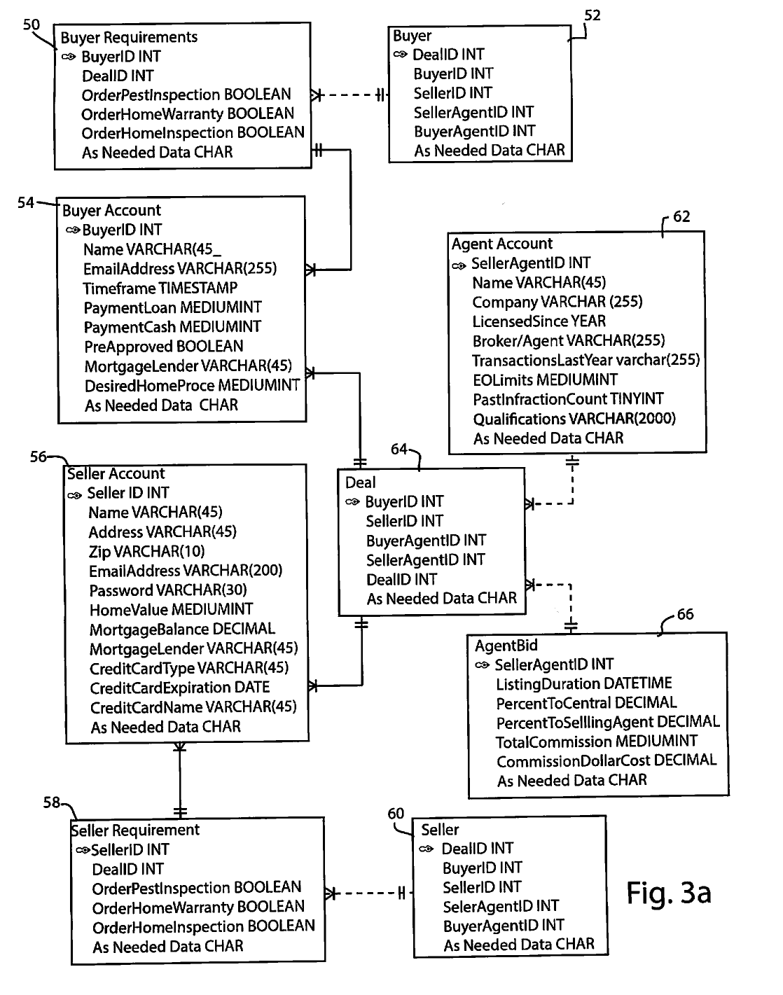

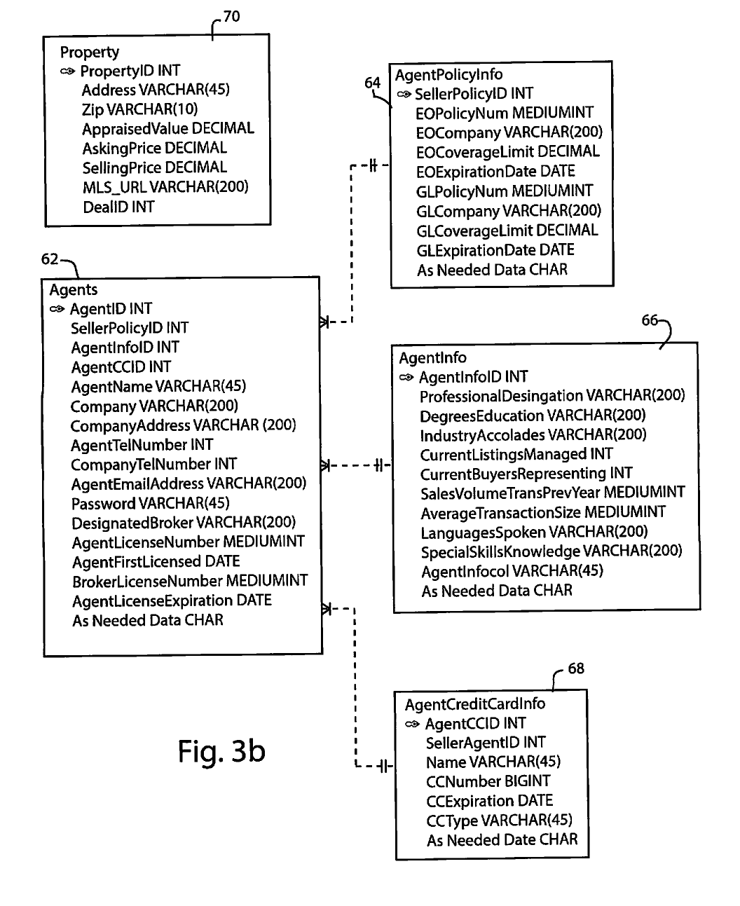

FIGS. 3a and 3b illustrate an exemplary relational database schema by which the backend database 110 may be configured. The schema comprises a set of related tables into which the data provided by the users are stored. It will be understood that these tables comprises data fields that store data in physical memory locations within the computer-readable memory device(s) associated with the computer.

The data processing tool automatically stores historical commission bid data and uses that bid data to assist a user in selecting and engaging a real estate agent. As part of its operation, the tool automatically updates the historical commission bid data as agents are engaged. Thus over time the system builds a rich data store of historical commission bid data that buyers and sellers can access and use in determining which agents they would like to request bids from.

### Seller Side Functionality

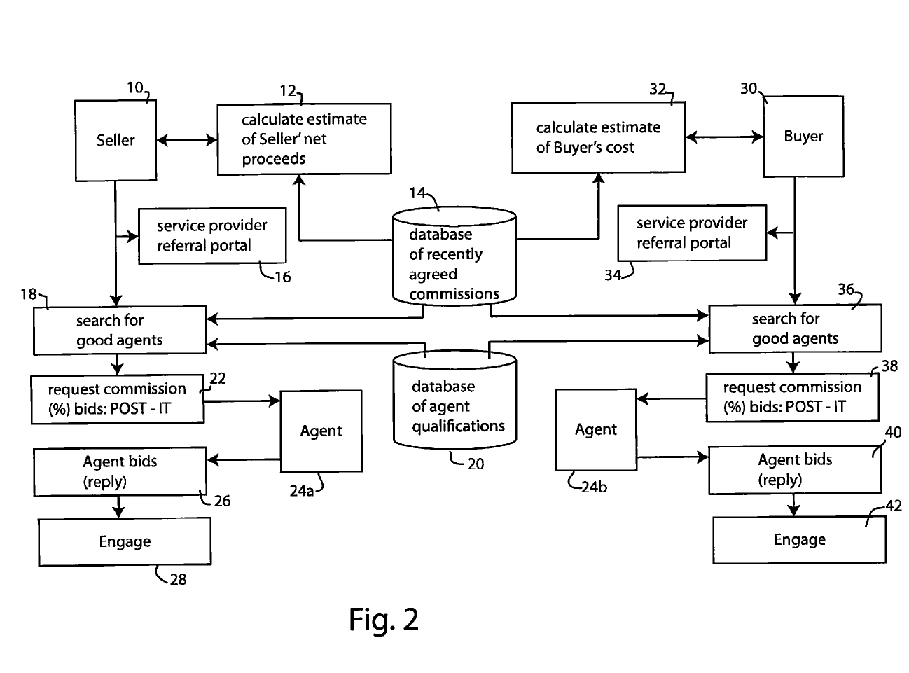

FIG. 2 illustrates this process both in the context of a seller seeking to engage an agent and in the context of a buyer seeking to engage and agent. We begin with the seller, depicted at 10. The seller registers with the data processing tool and enters basic information about his or her property to be offered for sale. Using the provided user interface screens generated by the tool, the seller provides data that are stored by the tool in the Seller Account table 56 (FIG. 3a) and Seller Requirements table 58 (FIG. 3a). The tool then uses the entered HomeValue and MortgageBalance data from table 56 to calculate an estimate of Seller's net proceeds, as at 12 (FIG. 2) using a range of commissions from the database of recently agreed commissions 14 maintained by the data processing tool, and also using a standard 6% rate. This estimated net proceeds information is published to the Seller via a web page. In this way the Seller can see at a glance how his or her net proceeds will be affected by different agent commission fee percentages.

In addition to providing the Seller with this useful information about estimated net proceeds, the tool also couples to selected third party service providers by means of a referral portal. The tool automatically suggests suitable service provider referrals based on the Address and/or Zip code fields in table 56 (FIG. 3a). The tool maintains a list of required and/or suggested ancillary service, such as pest inspection services, home warranty services and home inspection services that may be applicable to a particular geographic region or neighborhood or home price range.

From a system standpoint, the net proceeds calculation and ancillary service recommendations offered by the tool help engage the prospective Seller, educating the Seller on what can be expected and preparing the Seller in handling some of the ancillary matters ahead of time. However, at some point the Seller will want to use the tool to search for good agents to represent him or her in selling the property. This is where the tool becomes particularly useful. The tool allows the Seller to readily compare the qualifications of different agents, without alerting those agents that they are being compared. More importantly, the Seller can also see what bids these agents have agreed to in the past, for comparable properties. Using this information the Seller can make an informed decision of which agents he or she would like to consider for possible representation.

The tool performs this search for good agents, as at 18, by performing a query against the database of agent qualifications 20, while also pulling recently agreed commissions from database 14 for the agents retrieved. Specifically, the tool uses table 62 (FIG. 3a) and table 66 (FIG. 3b) where the database 20 of agent qualifications is maintained. The database 14 of historical commission bid data is stored in table 66 (FIG. 3a).

The database 14 of historical commission bid data can be configured to store all bids made in response to requests by Sellers and Buyers, even if those bids are not accepted. The data structure of the database may be configured to associate attributes to each stored bid, indicating whether the bid was in response to a request from a Seller or from a Buyer and whether the bid was accepted. In this way, the tool can later perform queries to select historical bid data that best addresses the parties' needs.

In a presently preferred embodiment, the bid data for bids actually accepted are used to generate market averages according to geographic region and timeframe. The tool generates the AVERAGE COMMISSION that has been agreed based on location (e.g., zip code and/or city and/or state) in the last 30, 60, or 90 days. This information is then provided to the Seller or Buyer, noting that the actual commission may be a reflection of a specialized property or the experience of the agent.

Once the Seller has decided which agents meet his or her desired qualifications, the Seller uses the tool to select those agents and causing the tool to issue bid requests to those agents through a POST-IT command as at 22. The tool broadcasts the bid request to each of the selected agents, shown as Agent 24a in FIG. 2 and then forwards all Agent bids back to the Seller in reply as at 26.

The tool effects this bid dissemination process by creating an Agent Bid record by populating table 66 (FIG. 3a) for each agent who responds to the Seller's request. In this way data for each responding bid is stored in database 20 and will initially be marked with a flag indicating the bid is an UNACCEPTED bid, and further marked with a flag indicating that the bid was in response to a Seller's request.

Once the Seller selects a particular agent to represent him or her, the Seller uses the tool to engage that agent, as at 28. The tool effects this by creating a record in the Deal table 64 (FIG. 3a) that serves to link the AgentBid table 66 record of the accepted bid with the Seller Account table 56. The tool then changes the flag for the accepted bid to indicate that it is an ACCEPTED bid. As noted above, in a presently preferred embodiment only accepted bids are used in computing the average commission that is maintained as historical data for a given location and timeframe.

At this stage, only the seller's agent is linked to the Deal table record. Assuming the property associated with the Seller Account (table 56) has not yet been listed for sale, then no buyer offers will be pending. Thus buyer information is not yet linked to the Deal table record.

### Buyer Side Functionality

Corresponding reference numerals indicate corresponding parts throughout the several views of the drawings.

FIG. 2 also shows the process by which buyers engage an agent to represent them in the purchase of real property. Buyer 30 interacts with the database of agent qualifications 20 and with the database of recently agreed commissions 14 in essentially the same fashion as Seller 10. The web screens generated by the tool for the Buyer-side functionality are comparable to the Seller-side screens described above.

The tool at 34 couples to selected third party service providers relevant to buyers by means of a referral portal. The tool automatically suggests suitable service provider referrals based on the Address and/or Zip code fields in table 56 (FIG. 3a). The tool maintains a list of required and/or suggested ancillary service, such as pest inspection services, home warranty services and home inspection services that may be applicable to a particular geographic region or neighborhood or home price range. In addition, the tool at 34 makes recommendation that the Buyer obtain pre-approval for a suitable mortgage, and automatically suggests suitable mortgage suppliers where pre-approval can be obtained. A Buyer with pre-approval for a mortgage sufficient to cover the purchase cost represents a high quality client to an Agent. Thus pre-approved Buyers may have better negotiating position to obtain a lower commission bid.

The tool at 36 allows the Buyer to search for good agents, by accessing the database of recently agreed commissions 14 and the database of agent qualifications 20, in a fashion similar to that for Sellers. Once the Buyer has selected one or more agents who appear suitable, the buyer uses the POST-IT action of the tool, at 38, to request bids from those Agents 24b. The Agents 24b respond at 40 and those responses are collected by the tool and stored in the AgentBid table 66 (FIG. 3a). The tool displays a list of the responding Agents 24b and the Buyer can then select one using the tool to engage that agent as at 42.

Agent Qualifications Tables

Corresponding reference numerals indicate corresponding parts throughout the several views of the drawings.

The database of agent qualifications 20 (FIG. 2) are stored in tables 62, 64, 66 and 68 as shown in FIG. 3b. The tool is flexibly configured to allow agents to act in the capacity of a Seller Agent or as a Buyer Agent. For illustration purposes, FIG. 3a illustrates how Seller Agent information are stored in relation to a particular deal. Specifically table 62 records some of the particulars of the agent's qualifications; table 66 records what that agent has bid for a particular request for bid from Seller. Additional information about the agent may be obtained from the related tables 62, 64, 66 and 68 in FIG. 3b. In this regard, the key index AgentID in Agent table 62 is linked by the tool to key index SellerAgentID in tables 62 and 66, when that agent is acting in the capacity of a Seller Agent. It will be understood that the data stored in the qualification table are merely intended to be exemplary; other qualification categories are also possible and are envisioned.

However, it should be kept in mind that tables 62, 64, 66 and 68 in FIG. 3b are used to store information about all agents, not only those who serve in the capacity of Seller Agent. Thus, although not shown, it will be understood that the data structure of FIG. 3a will also include tables based on the structure of tables 62 and 66 that are used to record information about the Buyer Agent for a particular deal (if such Buyer Agent is participating by offering Buyer a negotiated commission via the tool). In such case tables 62 and 66 would reference the key index BuyerAgentID, which would be related through the key index AgentID in Agent table 62.

### Agent Bid Table

The Agent Bid table holds the data from when an Agent enters a proposal to represent either a buyer or seller. The data can be seen by the Buyer or Seller on their HOMEPAGE under FEE POSTING RESULTS.

By way of example, assume the average home in Phoenix, Ariz. will sell for $260,000 and a typical commission is 6% paid as 3% or $7,800 to the Listing Agent (Seller's Agent) and 3% or $7,800 to the Selling Agent (Buyers representative).

If a Seller posts this home for LIST using the tool, and selects an agent that will do it for 4.5%, the split would be Seller's Agent 1.5% or $3,900, and Buyer's Agent 3% or $7,800. In this case Seller has saved $3,900. If the Buyer's agent has not bid anything different, a standard 3% is paid to the Buyer's Agent. In other words, Buyer's agent is allocated half of the normal 6%. The reason the tool allocates 3% to the Buyer's Agent 3% under these circumstances is because Sellers want to ensure that Buyer's agents will actively show the home. If Buyer's Agent side were cut, the home would likely be blackballed.

On the other hand, consider the case where the Buyer of this home uses the tool to find a Buyer's Agent. Under this example scenario it is assumed that the Seller has not used the tool. Assume that the Buyer's agent selected has agreed to represent the Buyer for 2% or $5,200 and the Buyer bought the home above. At the close, the Buyer's Agent would get $7,800 BUT he would rebate $2,600 to the Buyer as per the agreement for representing them.

Thus a bid accepted by the Seller is reflected by the tool as a reduction of the commission that is ultimately paid once the selling price has been agreed to and the deal is consummated at closing. Thus the Seller receives at closing the selling price minus the agreed commission and minus any other governmental or bank transactional fees. However, a bid accepted by the Buyer is reflected by the tool as a rebate amount to be paid to Buyer, taken from the Buyer Agent's share of a standard commission.

### Consummation of Real Estate Purchase

As explained above, the tool maintains essentially independent records of Seller-Agent relationships and Buyer-Agent relationships, using primarily tables 56, 58 and 60 for Seller and tables 50, 52 and 54 for Buyer. Within the tool it is the Deal table 64 that defines a specific relationship between a buyer and a seller. Note that Deal table 64 stores data identifying the key information needed to identify the players, namely: BuyerID, SellerID, BuyerAgent ID, SellerAgent ID, and information to identify the particular property, namely: DealID.

When a meeting of the minds occurs between buyer and seller, such that both have entered into a contract relating to ownership or possession of a particular piece of real estate, data are written into each of the fields of the Deal table 64. In this way the tool creates a record from which all of the particular information needed to consummate the transaction are recorded. Note that the DealID corresponds to in integer value that is indexed by the tool to uniquely represent each transaction. The DealID points to a Property table 70 (FIG. 3b) containing particulars of the property, including details on location, asking prices, selling price and other particulars about the property. Such particulars can include a pointer, if desired, to the applicable MLS listing for that property.

### Tool Middleware

In implementing the system illustrated in FIG. 1, the Tool comprises a collection of executable program computer code that runs on the backend database computer 102 and on web server 104 to store and retrieve data from the data structures shown in FIGS. 3a and 3b, to perform the various calculations and database queries responsible for effecting the Tool's behavior. This executable program computer code is implemented using HTML to define the user interface screens and further using executable code running either on the client side or the server side to implement the middleware used to define the business logic 118a.

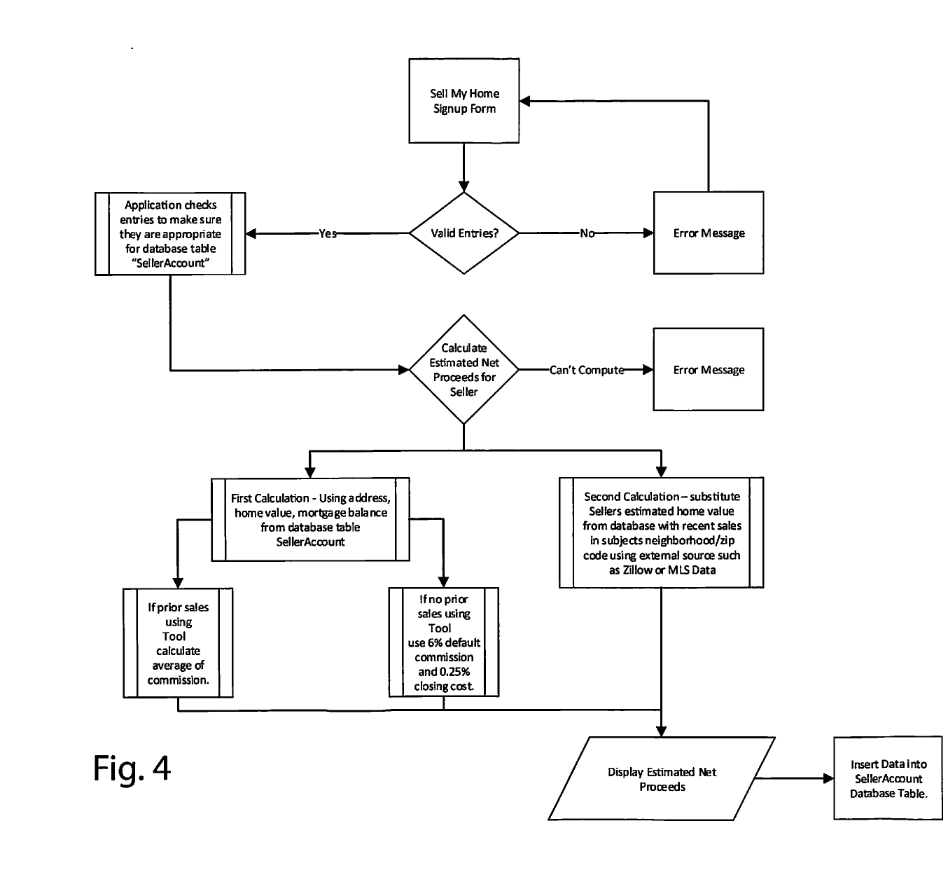

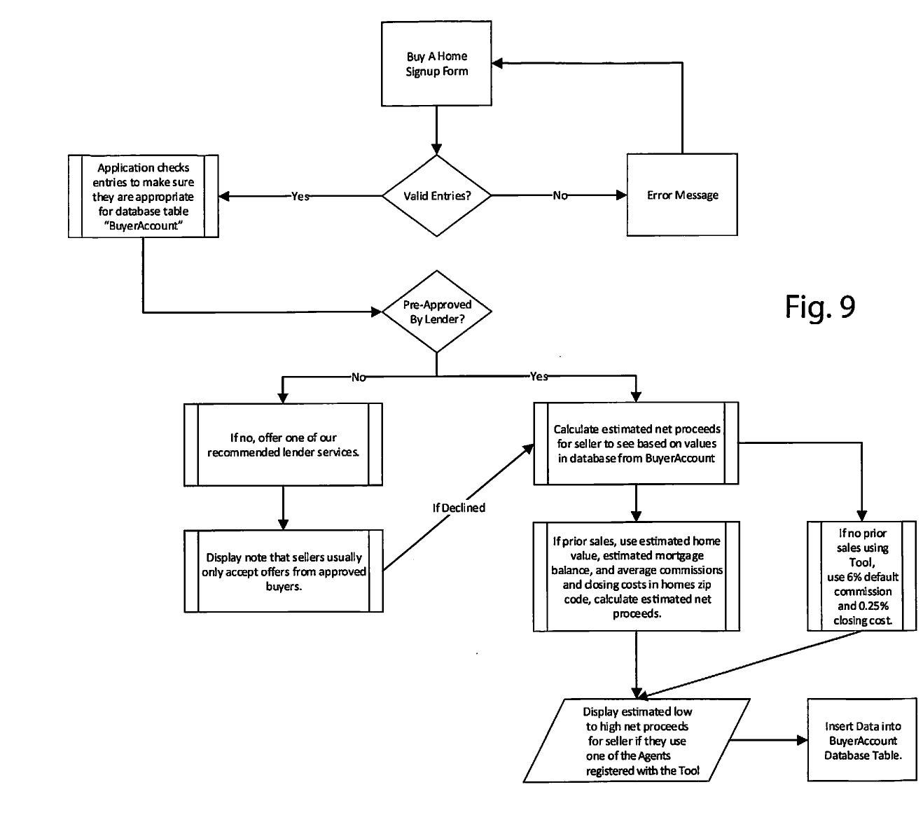

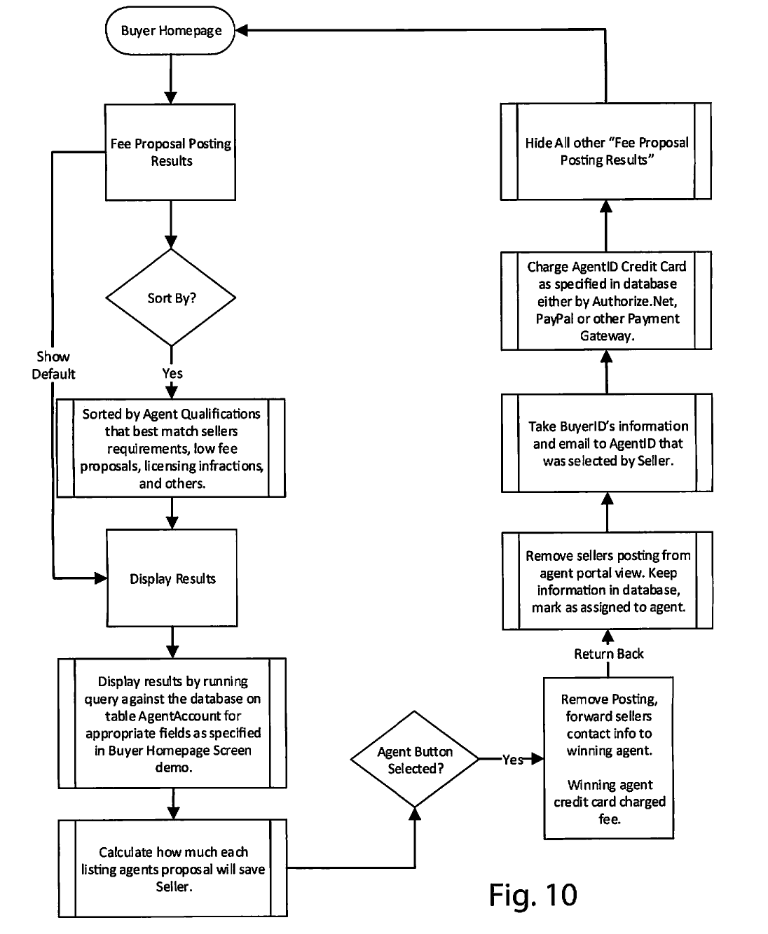

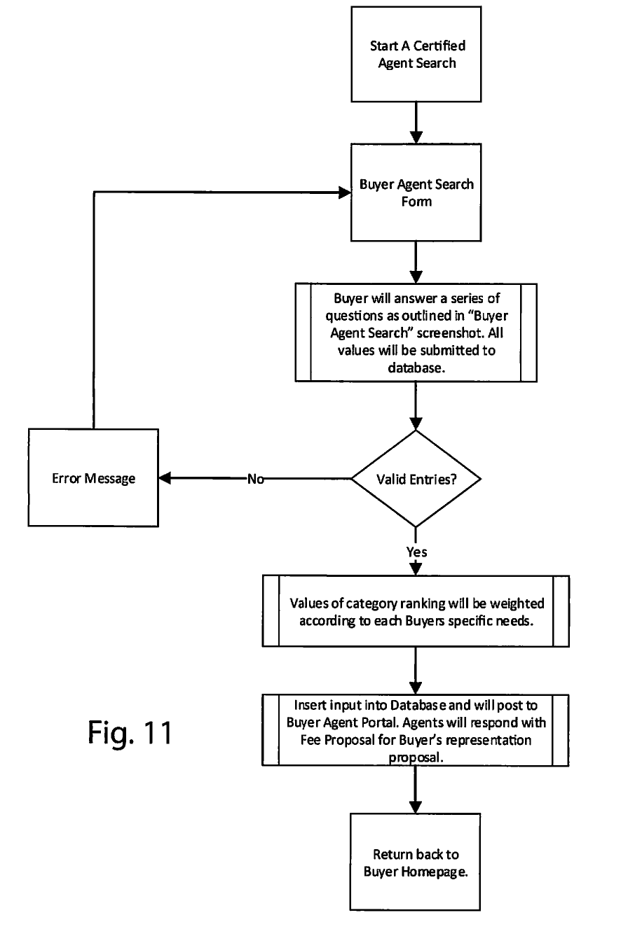

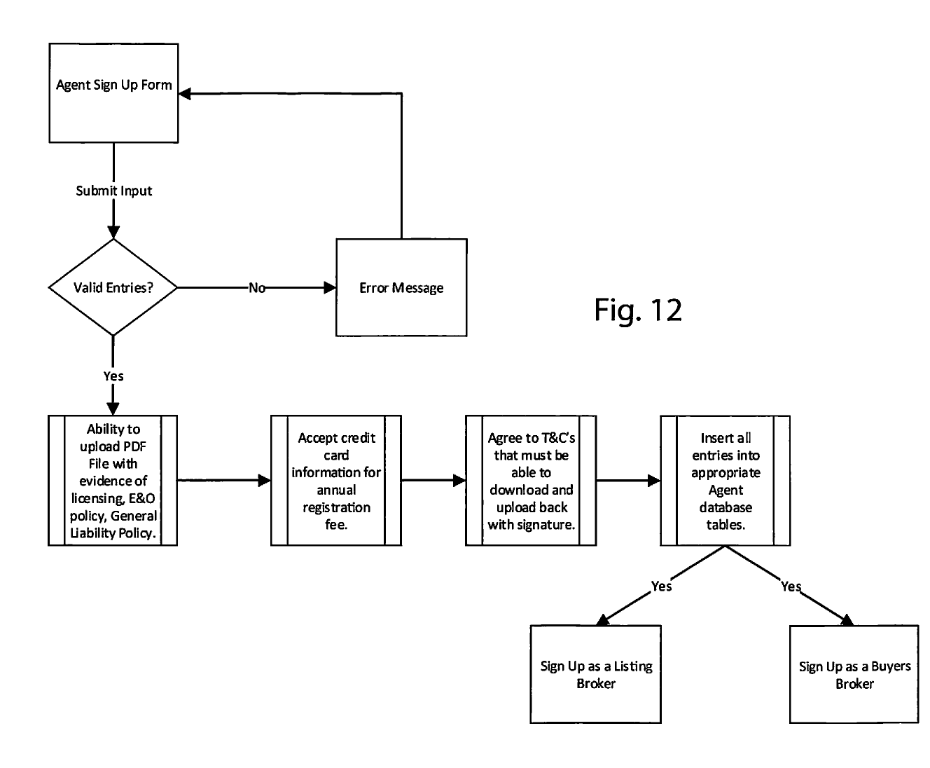

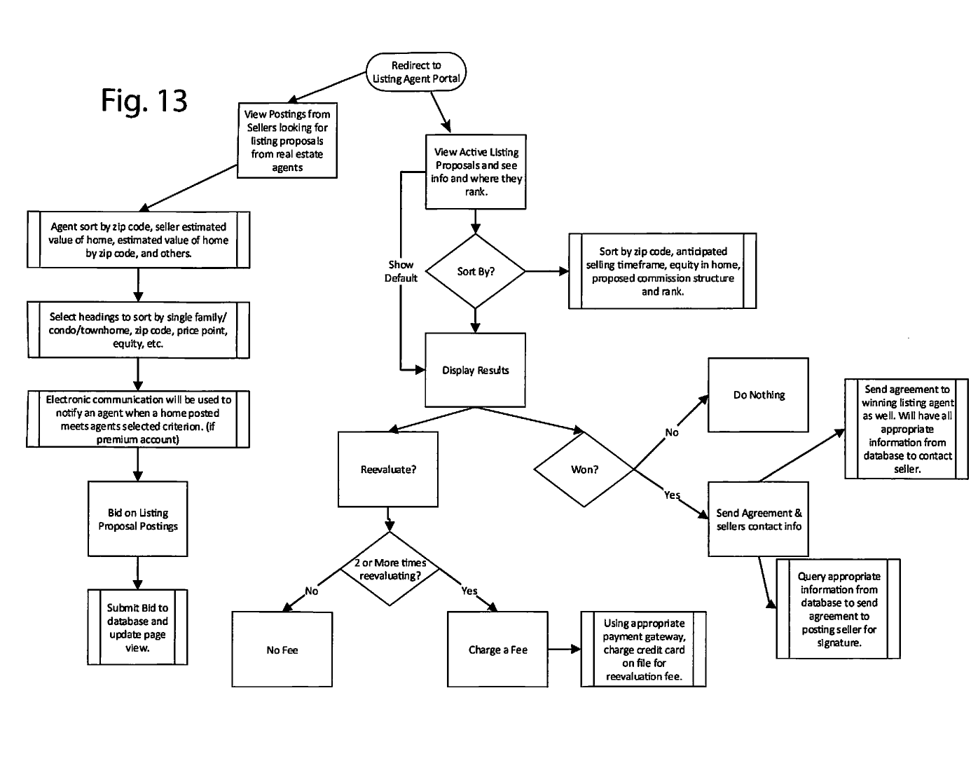

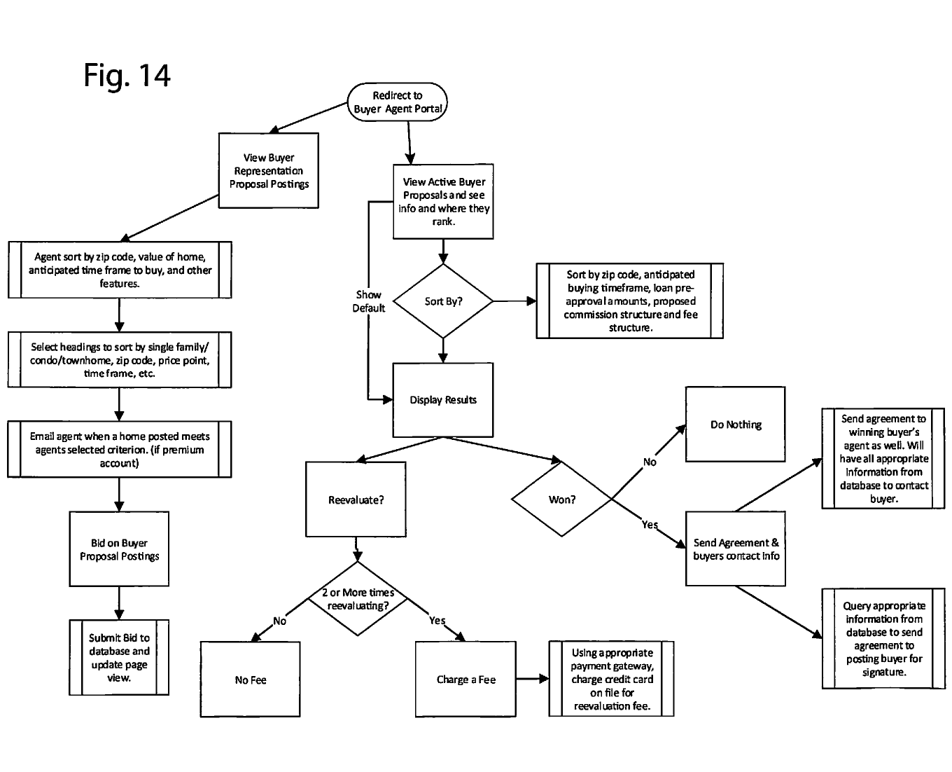

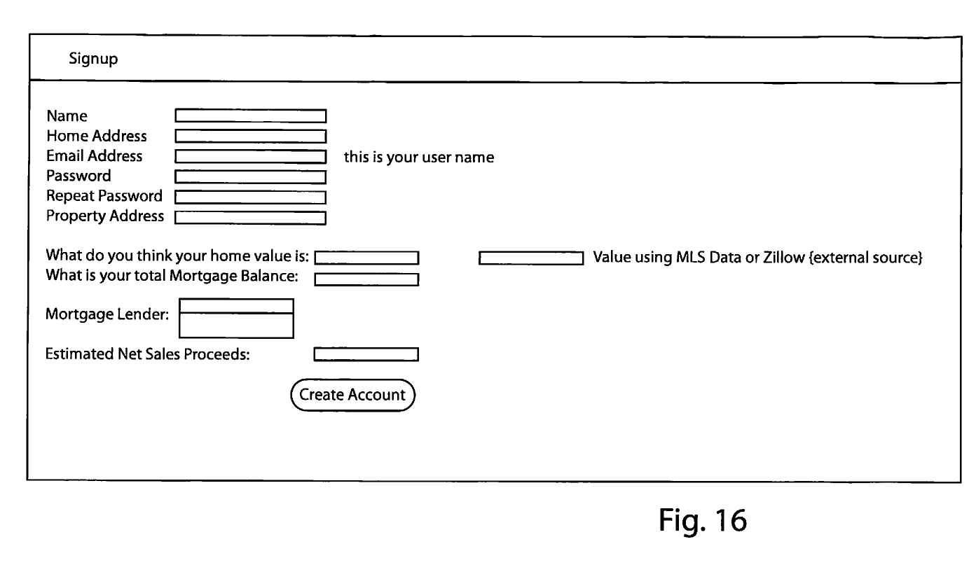

FIGS. 4-14 show the middleware programming logic and algorithms in greater detail. In the preferred embodiment the middleware logic can be executed from different starting points. Thus for illustration purposes the explanation will begin with FIG. 4 at the step where a Seller accesses the Tool to sign up to sell a home. An exemplary web screen suitable for use in the sign up process is shown in FIG. 16.

As seen in FIG. 4, the middleware tests the accuracy of the Seller's input information and then proceeds to calculate an estimated net proceeds value for the Seller, based on several different methods described in FIG. 4. Because the Seller is usually quite interested in knowing this net proceeds value, the Tool gives the Seller immediate gratification by supplying this value, as inducement to register with the Tool. The Tool generates a user interface, such as a web screen (see FIG. 16 as an example) that collects basic information needed to create a unique record for the enrolling Seller. The same screen preferably also includes fields to prompt the user to enter sufficient information to allow the Tool to calculate an estimated net sales proceeds value. Calculating this number engages the would-be Seller and invites the Seller to create an account by pressing the convenient Create Account button on the user interface screen as seen in FIG. 16.

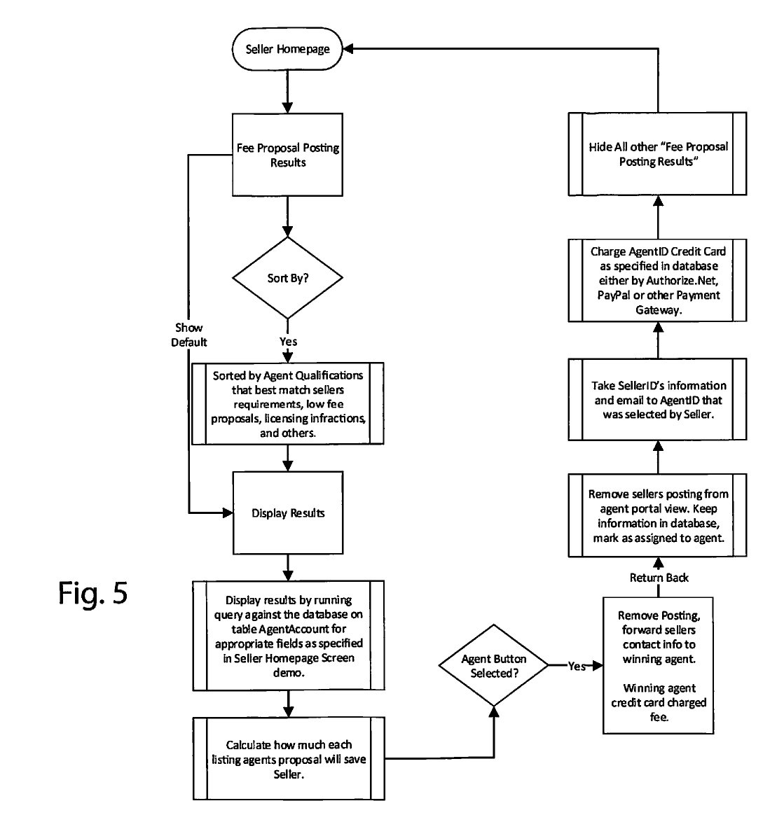

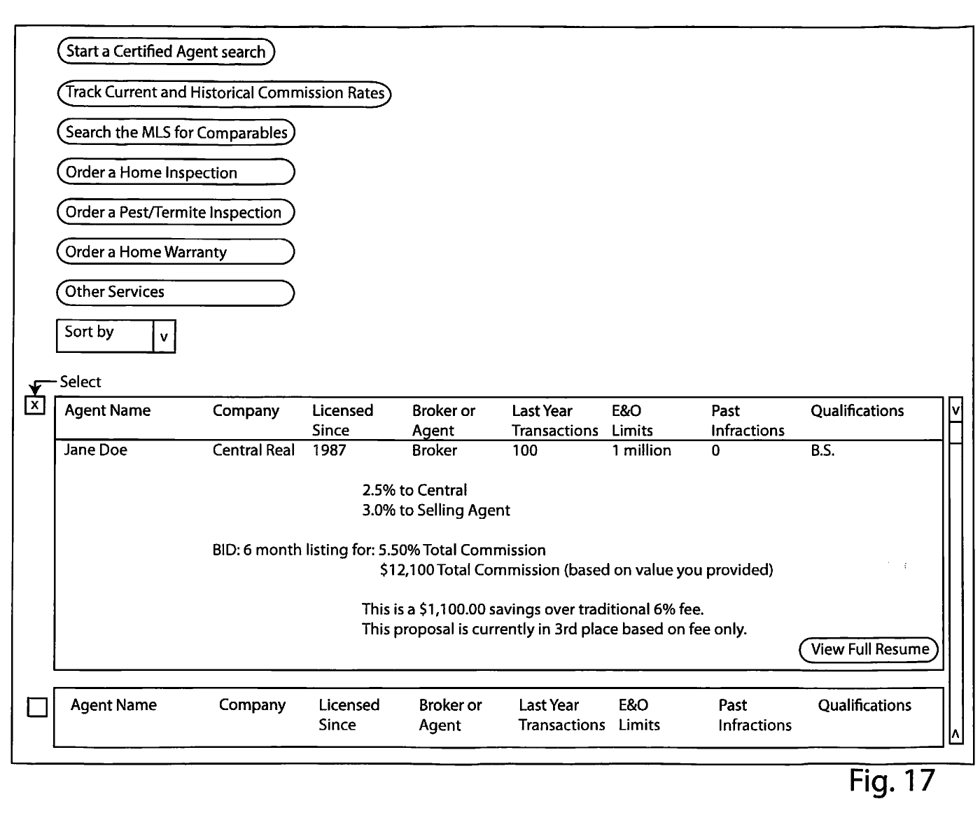

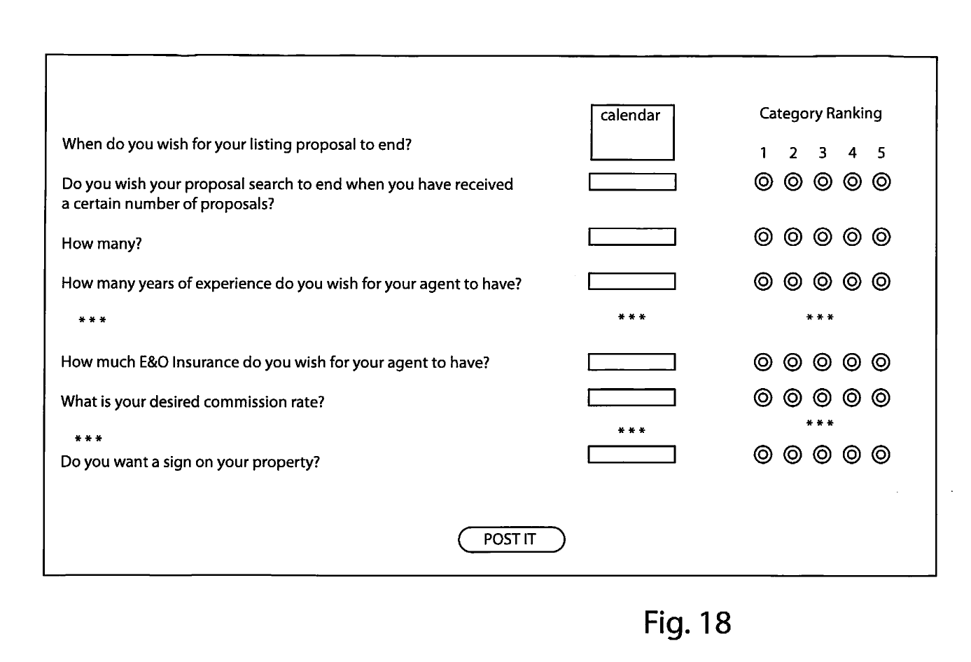

As seen in FIG. 5, when a Seller has successfully registered with the system, the Tool generates a Seller Homepage (FIG. 17) from which fee proposal postings are displayed in a sorted order that can be controlled by the Seller. The Seller Homepage also lists additional services that the Seller can click on to purchase or investigate. If the Seller has not yet requested any fee proposals, or if the Seller wants to obtain additional proposals, the Tool runs a query against the database containing the AgentAccount table, seeking agents that meet the Seller's requested criteria. These criteria are input on a convenient Agent Search screen (FIG. 18). Results of the query are displayed on the Seller Homepage (FIG. 17) comprising individual listings which the user can select or deselect to choose which Agents the request for bids should be sent to.

To make the entry of such qualifications easier for the Seller, in one embodiment the Tool displays a demo Homepage screen with initial criteria selected for measuring agent qualifications. The Homepage allows the Seller to modify those initial criteria and then the Tool refreshes the page to show those criteria. For example, the default (demo screen) may show Sales volume transactions for the previous year [SalesVolumeTransPrevYear—Table 66 FIG. 3b], but suppress the agent's languages spoken [LanguagesSpoken]. If the Seller wishes to change this he or she can, for example, modify the demo screen defaults, to suppress the sales volume criteria and include the languages spoken criteria.

The executable code illustrated in FIG. 5 also contains the procedure whereby the Tool responds to a seller's acceptance of a particular agent's bid, through selection of a button associated with the selected Agent's name.

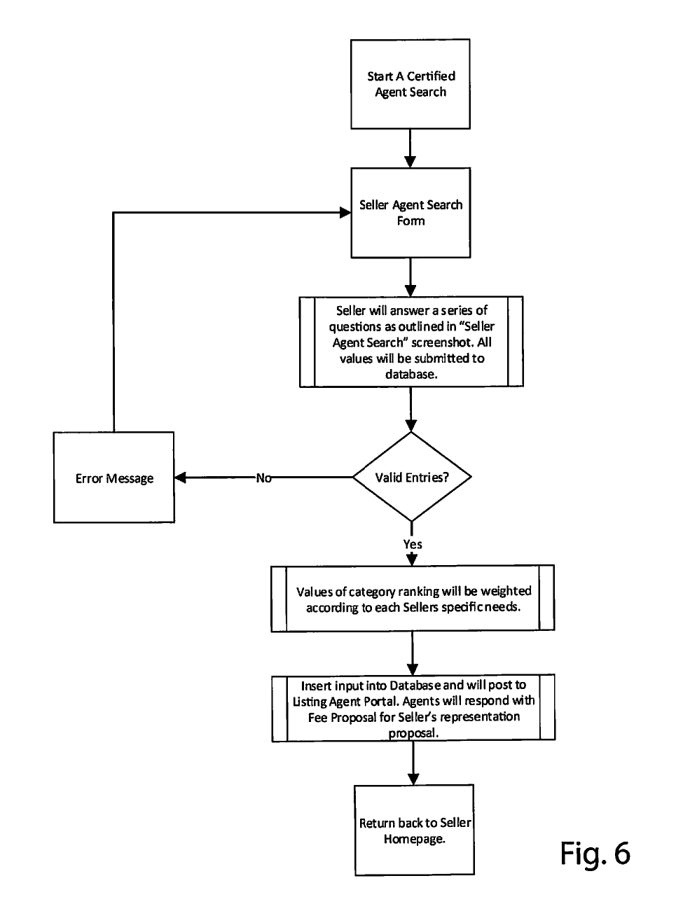

FIG. 6 shows the algorithm by which the Tool conducts an agent search query, corresponding to step 18 (or step 36) of FIG. 2. The algorithm prompts the Seller with a series of questions designed to elicit information needed to assess what that Seller deems important in an Agent candidate. In a preferred embodiment the screen prompts the user to enter numerical answers to questions, like “How many years of experience do you wish for your agent to have?” Associated with each question is a category ranking selector by which the user can select on a 1-5 scale how important that question is (1 being “not at all important,” and 5 being “very important”). An exemplary illustration of the question ranking feature is shown in FIG. 18.

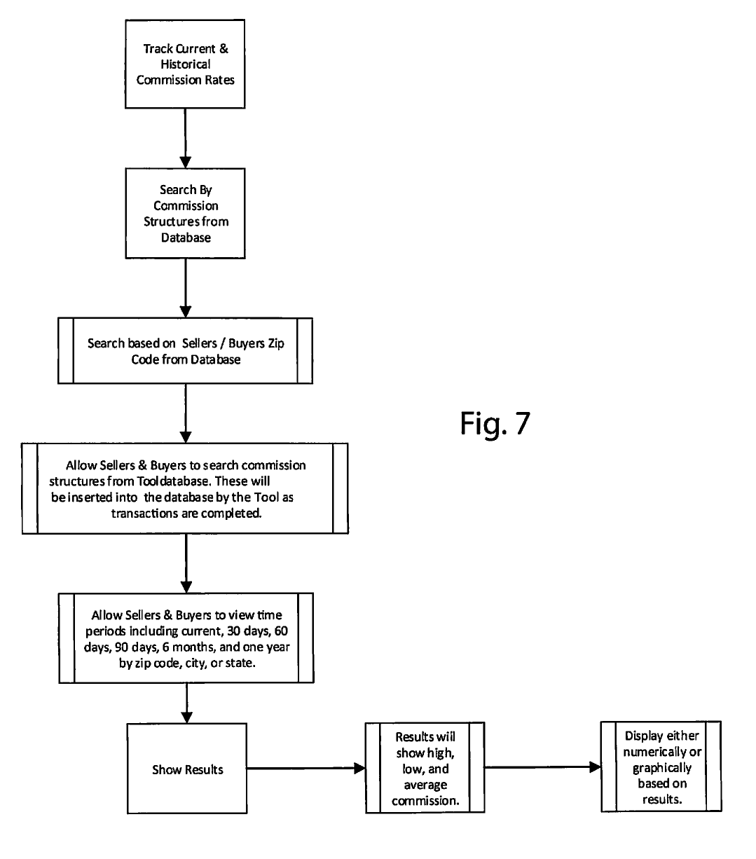

In addition to searching Agent qualifications, the middleware also provides algorithms for searching historical commission bid data. This is illustrated in FIG. 7. The algorithm shown at FIG. 7 corresponds to the operation of accessing the database 14 (FIG. 2) as part of step 18 (for Seller) and step 36 (for Buyer).

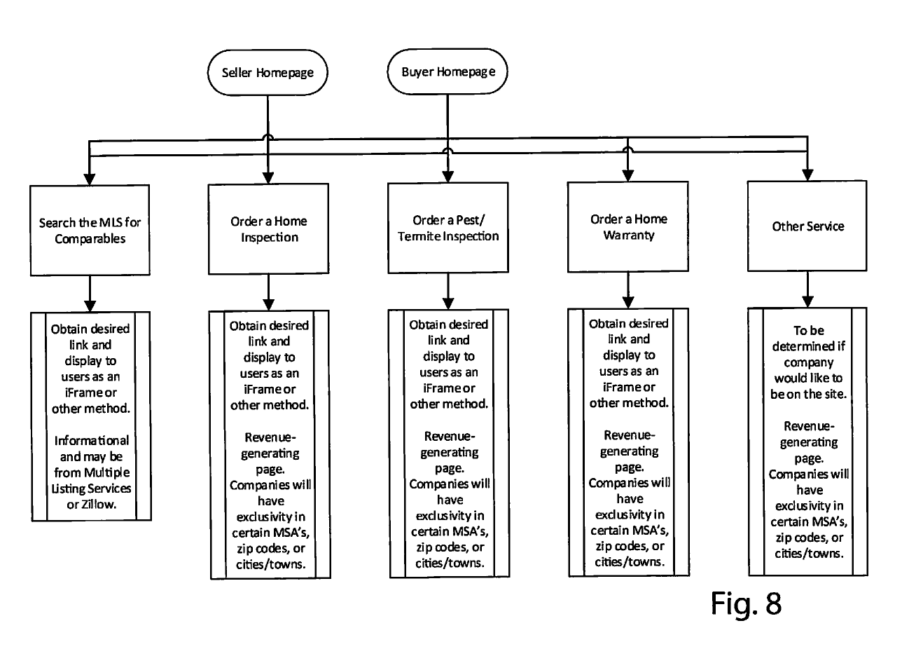

FIG. 8 shows the algorithm by which the middleware business logic determines what service provider referral portals are displayed. As illustrated, some portals are offered to both Sellers and Buyers. Other portals are limited to Sellers only, or Buyers only. For example, as illustrated in FIG. 8, only Sellers are offered the “Order a Home Warranty” service; only Buyers are offered “Order a Pest/Termite Inspection.” In a presently preferred embodiment, the referral portals are provided by identifying a URL link and displaying the information associated with that link using an HTML iFrame.

### Agent Portal

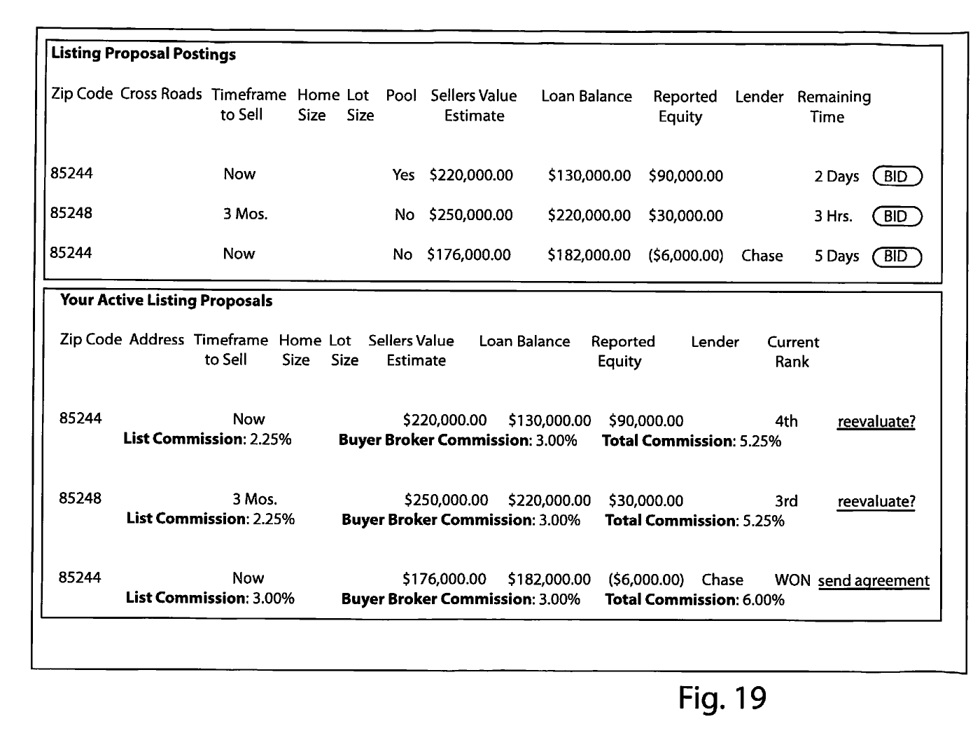

Shown in FIG. 19, the Tool generates and presents to each Agent acting as a Listing Agent (representing Seller) a Listing Agent Portal screen which shows all properties for which requests for quote have been sent by the Tool to that agent. Each proposed posting indicates the amount of time remaining for submission of bids and also includes a BID button that the Agent can click to enter a bid for that property.

The Listing Agent Portal screen also shows in a separate frame or window a list of all active proposals (proposals for which the agent submitted a bid). The Tool generates the list in such a fashion that each entry on the listing tells the Agent where his or her bid ranks among all of the bids submitted. Although the Agent does not see what the other bid amounts are, or who made them, each Agent can still get some measure of whether their bids are commensurate with current market expectations. Each bid listing also includes a convenient hyperlink that the agent can click on to revise or reevaluate his or her bid. Such reevaluation may be tied to the agent's credit card on file with the Tool being charged. The Listing Agent Portal screen also indicates which bids have been won, and gives the Agent a convenient hyperlink that transfers control to a separate screen or system that will generate the agreement forms as needed to consummate the agent relationship.

### Anti-Spoofing

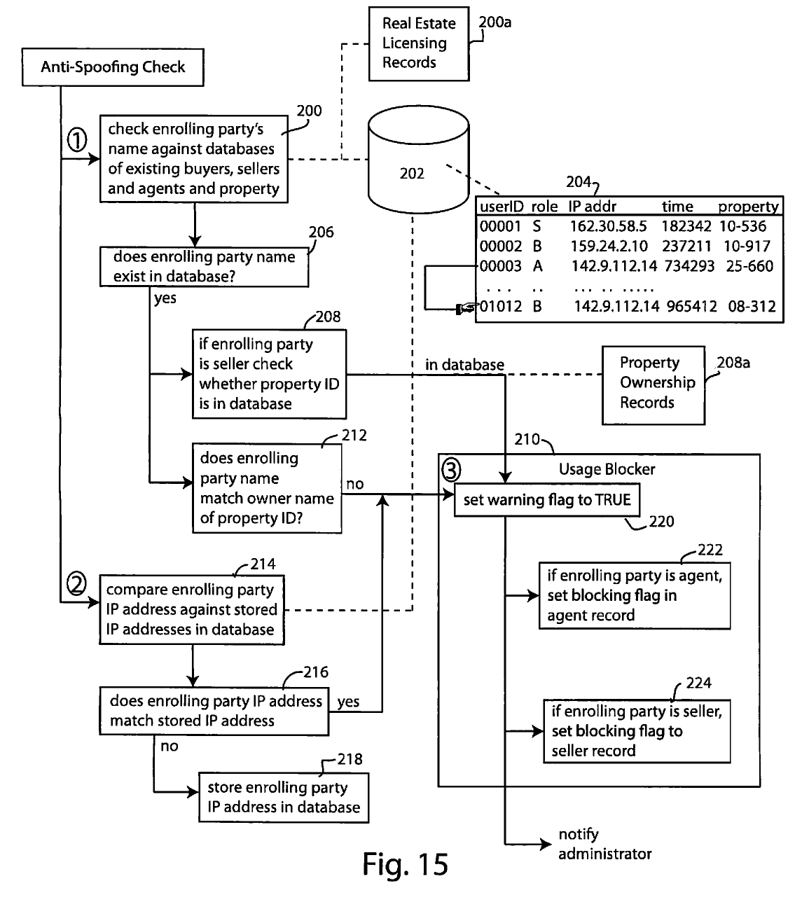

To prevent agents from posing as a buyer or seller and thereby gaming the system, the Tool employs anti-spoofing technology. The algorithm is illustrated in FIG. 15. First, when each new buyer or seller registers with the system, the Tool performs an automated crosscheck 200 of the buyer or seller's name with the State Real Estate licensing database 200a. In addition, if the person seeking to register is a Seller the Tool performs an automated crosscheck 208 against the property ownership records 208a to detect if the person is actually the owner of the property being offered for sale. In this way the Tool can quickly identify situations where someone is posing as a buyer or seller in effect to surreptitiously learn about other agents' bidding practices.

While this first simple name crosscheck will catch some persons attempting to game the system, the Tool performs a second more sophisticated check by recording and storing the IP address associated with each party who is accessing the system. This includes storing the IP address of all buyers, sellers and agents in a database 202 when they first enroll to use the Tool. The Tool then compares, at 214, the IP addresses of buyers and sellers with the IP addresses stored in the database. The Tool flags cases where the IP address of a buyer or seller matches that of an agent, and also flags cases where the IP address of a buyer or seller matches the IP address of a different person previously registered. This is done by recording the asserted role [seller ‘S’ buyer ‘B’ agent ‘A’] in the data table 204. Upon detection, the Tool blocks further use of the Tool, giving the user a message to contact a service telephone number in order to remove the blockage.

The Tool records the IP addresses of all buyers and sellers, recording the date and time of each interaction, preferably in the form of a numeric timestamp, and the identifier of the property in question; see table 204. If the Tool detects the same IP address repeatedly showing up (as when an agent uses a home computer masquerading as a seller and “games” system and then one month later he does it again) and if no deal was consummated the first go around and/or the property addresses are different, then the Tool blocks further transactions of that user, notifying the user to contact a service telephone number to “clear” the blockage in order to proceed. For illustration purposes, table 204 shows an instance where the same IP address has registered both as an agent ‘A’ and as a buyer ‘B’. This example would be caught by the Tool as evidence that an agent is trying to masquerade as a buyer.

There will be some sellers with multiple properties for sale and the Tool permits this activity. Specifically in these instances, once a user is “flagged” as being a potential masquerader, the Tool initially blocks usage, but this block can be overridden to permit multiple properties to be sold concurrently.

Whenever one of these crosschecks determines that a possible spoofing situation has occurred, a message is broadcast to the usage blocker code 210 within the Tool, which sets a warning flag associated with the enrollee's name to TRUE and then takes additional automatic protective action if warranted, such as setting a blocking flag to TRUE if the party is an agent; or setting a blocking flag to TRUE if the enrolling party is a seller. The usage blocker code 210 also issues a notification message to the Tool administrator, to allow the administrator to contact the enrolling party and remove the blocking flag if conditions warrant.

Using the blocking flag, the Tool permits parties to be blacklisted from further use of the system, if the party is found to have repeatedly abused the system. This blacklisting is accomplished by saving blacklisted IP addresses in the database where the Tool uses those to refuse access to the system, and/or by charging an appropriate penalty via the agent's credit card which the Tool stores on file. Charging a penalty to the agent's credit card would be governed by a suitable agent agreement between the agent and the administrator of the Tool.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An apparatus that automatically stores historical commission bid data and uses that bid data to assist a user in selecting and engaging a real estate agent, comprising:
a computer-readable memory device having first memory locations allocated to store historical commission records comprising an agent identifier and an associated value indicative of a commission for representation in connection with a transaction;
a computer-readable memory device having second memory locations allocated to store agent qualification records comprising an agent identifier and at least one associated datum indicative of an agent qualification;
a computer programmed to access the first and second memory locations and to perform a query that retrieves agent identifiers that associate with at least one of a user specified value indicative of a commission and a user specified datum indicative of an agent qualification;
the computer being further programmed to store in a third memory location of said computer-readable memory device the agent identifiers retrieved from said query and to generate a first report to the user that supplies at least the agent identifier for all agents who meet at least one of the commission and agent qualification corresponding to the user specification;
the computer being further programmed to post a request for commission bid on behalf of the user to each agent corresponding to the retrieved agent identifiers;
the computer being further programmed to receive and store in a forth memory location of said computer-readable memory device a commission bid reply from at least one agent having received the posted request for commission bid;
the computer being further programmed to generate a second report to the user that supplies at least the agent identifier and associated commission bid reply for all responding agents having replied to the posted request for commission bid;
the computer being further programmed to store in said historical commission records the agent identifier of one of the responding agents together with the associated commission bid reply based upon selection of the one responding agent by the user.

2. The apparatus of claim 1 wherein the computer is programmed to store in a fifth memory location of said computer-readable memory device a service provider identifier and wherein the computer is further programmed to provide information based on the service provider identifier to the user.

3. The apparatus of claim 1 wherein the computer is programmed to store in a fifth memory location of said computer-readable memory device a service provider identifier in association with a geographic location identifier;
wherein the computer is programmed to store in a sixth memory location of said computer-readable memory device a real property identifier in association with a geographic location identifier; and
wherein the computer is further programmed to access the fifth and sixth memory locations and to perform a query that retrieves and displays to the user information based on service provider identifiers having geographic location identifiers that match geographic location identifiers associated with real property identifiers.

4. The apparatus of claim 1 wherein the computer is programmed to include an anti-spoofing mechanism to inhibit a user registered as an agent from masquerading as a buyer or seller comprising a data store of IP addresses compiled by the computer based on previous user registrations and comprising executable computer program code that causes the computer to perform an automatic comparison of the IP address of the user against the data store of IP addresses.

5. The apparatus of claim 1 wherein the computer is programmed to include an anti-spoofing mechanism to inhibit a user registered as an agent from masquerading as a buyer or seller comprising a data store of property identifiers and associated timestamps and comprising executable computer program code that causes the computer to perform an automatic analysis of the data store of property identifiers to detect if a single user requests bid within a predetermined timeframe on a number of properties that exceed a predetermined number.

6. A computer-implemented apparatus to facilitate interaction among parties to a real estate transaction, comprising:
a database management system configured with data structures in which to store information about buyers, sellers and agents to a real estate transaction;
at least one computer coupled to said database management system and programmed to provide the following user interfaces:
a seller interface through which a real estate seller enters for storing in said database management system information about real property being offered for sale;
a buyer interface through which a real estate buyer enters for storing in said database management system information about real property the buyer is interested in;
an agent interface through which agents register to be eligible to represent either buyer or seller in a real estate transaction and enters for storing in said database management system bids to a buyer or a seller regarding terms that agent is willing to accept regarding the representation;
said at least one computer being programmed to communicate agent bids to a buyer or a seller based on queries submitted by said buyer or seller.

7. The computer-implemented apparatus of claim 6 wherein the computer is further programmed to calculate as follows:
from at least one of the address, estimated home value, mortgage balance, and average commissions and closing costs in the zip code where the real property is located, the computer calculates the estimated net proceeds for the seller.

8. The apparatus of claim 7 wherein the computer is further programmed to provide a second calculation that substitutes the seller's estimated home value for the home value derived by using recent sales in the subject's neighborhood or zip code, and then provides the estimated net sales proceeds based on the second calculation.

9. The computer-implemented apparatus of claim 6 wherein the computer is further programmed as follows:
the computer maintains a schedule sortable by criteria selected from the group consisting of agent qualifications matching the seller's requirements, low fee proposals, licensing infractions, whereby agents can be ranked according to each seller's custom wishes.

10. The computer-implemented apparatus of claim 6 wherein the computer is further programmed as follows:
the computer calculates how much each listing agent's proposal will save the seller as compared to what a predetermined fee would be and over what the fees have been over a predetermined or selectable period.

11. The computer-implemented apparatus of claim 6 wherein the computer is further programmed as follows:
each of seller's listing criteria are weighted according to each seller's specific needs, supporting categories selected from the group consisting of: years of agent experience, annual transaction count, average sales price achieved, E&O limits, general liability limits, distance of office from sellers home, maximum length of listing, desired commission rate, signage restrictions.

12. The computer-implemented apparatus of claim 6 wherein the computer is further programmed as follows:
the computer is programmed to permit sellers and buyers to search for commission structures within the computer for at least one of a past time period, a zip code, a city, and a state.

13. The computer-implemented apparatus of claim 6 wherein the computer is further programmed as follows:
from at least one of the estimated home value, estimated mortgage balance, and average commissions and closing costs in the homes zip code, the computer will calculate the estimated net proceeds for the Seller to see, where the commission amounts used in this calculation are derived from the computer's database of recently matched agents and sellers or buyers.

14. The computer-implemented apparatus of claim 6 wherein the computer is further programmed as follows:
the computer maintains a schedule that has the ability to be sorted by criteria selected from the group consisting of agent qualifications that match the buyer's requirements, low fee proposals, and licensing infractions, whereby agents are ranked according to each buyer's custom wishes.

15. The computer-implemented apparatus of claim 6 wherein the computer is further programmed as follows:
the computer calculates how much each agent's proposal will save the buyer as compared to a predetermined fee.

16. The computer-implemented apparatus of claim 14 wherein the computer further calculates how much each agent's proposal will save a buyer as compared with historic fees charged over a predetermined time period.

17. The computer-implemented apparatus of claim 6 wherein the computer is further programmed as follows:
each of buyer's representation criteria has the ability to be weighted according to each buyers specific need, supporting categories selected from the group consisting of: years of agent experience, annual transaction count, average sales price achieved, E&O limits, general liability limits, distance of office from desired buying city, homes sold in the desired city, maximum length of buyer broker agreement, desired commission rebate rate, and where the buyer will be able to rank each of the categories by those that are the most important to them and those that are the least important to them, where the computer will weigh the rankings and provide results to the buyer's custom agent search.

18. The computer-implemented apparatus of claim 6 wherein the computer is further programmed to support the following:
the agent will be able to sort seller postings by zip code, seller estimated value of home, seller estimated value of home by zip code, or any other feature that is useful to the agent;
agents will be able to select criteria that is important to them and have their potential postings ranked using variables selected from the group consisting of type of structure zip code, price point, and equity in home.

19. The computer-implemented apparatus of claim 6 wherein the computer is further programmed to support the following:
the agent is able to sort their listing proposals by zip code, anticipated selling timeframe, equity in home, their proposed commission structure, and by how they are ranked by fee structure on any posting at any given time;
if the agent's fee structure is not in the running, the agent has the ability to reevaluate their fee structure, including optionally reevaluating once for free and thereafter at an additional fee.

20. The computer-implemented apparatus of claim 6 wherein the computer is further programmed as follows:
upon winning the lead referral, the computer will auto generate a listing agreement that will be sent directly to the posting seller for signature, where the winning listing agent will receive a copy as well and will use the listing as a follow up document and where the listing will have all of the sellers contact information in it so that the winning agent can make contact and go to work.

21. The computer-implemented apparatus of claim 6 wherein the computer is further programmed to support the following:
the agent will be able to sort buyer postings by zip code, value of home, anticipated time frame to buy, or any other feature that is useful to the agent. agents will be able to select criteria that is important to them and have their potential postings ranked using variables selected from the group consisting of type of structure, zip code, price point, and time frame.

22. The computer-implemented apparatus of claim 6 wherein the computer is further programmed to support the following:
the agent is able to sort their proposals by zip code, anticipated buying timeframe, loan pre-approval amounts, their proposed commission structure, and by how they are ranked by fee structure on any posting at any given time
if their fee structure is not in the running, they have the ability to “reevaluate” their fee structure, and optionally allowed to reevaluate once for free and thereafter for an additional fee.

23. The computer-implemented apparatus of claim 6 wherein the computer is further programmed as follows:
upon winning the lead referral, the computer will auto generate a buyer broker agreement that will be sent directly to the posting buyer for their signature, and where the winning buyer's agent will receive a copy as well and will use the buyer broker agreement as a follow up document, and where the agreement will have all of the buyers contact information in it so that the winning agent can make contact and go to work.

24. The computer-implemented apparatus of claim 19 wherein the agent's ability to reevaluate their fee structure is conditioned upon payment.

25. The computer-implemented apparatus of claim 22 wherein the agent's ability to reevaluate their fee structure is conditioned upon payment.
